(19) United States
(12) Patent Application Publication
(10) Pub. No.: US 2009/0138884 A1
(43) Pub. Date: May 28, 2009

(54) STORAGE MANAGEMENT SYSTEM, A METHOD OF MONITORING PERFORMANCE AND A MANAGEMENT SERVER

(76) Inventors: Tomoaki KAKEDA, Yokohama (JP); Nobuo Beniyama, Yokohama (JP); Kazuki Takamatsu, Kawasaki (JP)

Correspondence Address: MATTINGLY & MALUR, P.C., 1800 DIAGONAL ROAD, SUITE 370, ALEXANDRIA, VA, 22314, US

(21) Appl. No.: 12/020,925

(22) Filed: Jan. 28, 2008

(30) Foreign Application Priority Data
Nov. 22, 2007 (JP) 2007-302472

(51) Int. Cl. G06F 9/46

(52) U.S. Cl. 718/104

(57) ABSTRACT

A storage management system provides a capability of properly setting a performance monitoring threshold and monitoring a performance of a storage resource in the SAN environment with respect to the operation process being executed. The storage management system includes a management server, a storage device, a storage network, and a management server. The management server is arranged to have a performance information collecting unit for collecting the current performance value of a storage resource, a composition section determining unit for determining a composition section corresponding with a composition ratio of the operation processes, a threshold information storage unit for storing a performance monitoring threshold corresponding with the composition section with respect to one or more storage devices, and a performance determining unit for determining a performance of the storage resource based on the current performance value and the performance monitoring threshold.

### INCORPORATION BY REFERENCE

The present application claims priority from Japanese application JP2007-302472 filed on Nov. 22, 2007 the content of which is hereby incorporated by reference into this application.

### BACKGROUND OF THE INVENTION

The present invention relates to a technology of monitoring performance characteristics of a storage device and a storage network.

Today, it is expected to reduce the management cost of a storage device and to effectively use a storage capacitance by building a SAN (Storage Area Network) served as a dedicated network between the storage device (often referred simply to as the storage), which is a large-scaled storage device made up of disk devices and the like, and a server so that a storage environment may be integrated through the network. In order to monitor or tune the performance of a business-operating system in the SAN environment, it is likely to be important to monitor the performance of storage resources distributively located on the network, such as the storage devices being used in the business-operating system or network devices located on the SAN.

On the other hand, it has been common to cause an operation-managing program run on managing servers connected through a management network to collect the performance information of objects whose performances are to be monitored such as the storages and the network devices distributively located on the network (SAN) on the time-series basis and to execute the performance monitoring operation based on the collected performance information. Further, to monitor the performance of the objects, it is possible to commonly use the method of predicting a problem on performance and detecting it by monitoring the collected performance values on the basis of a predetermined threshold value. In addition, the specification of U.S. Pat. No. 6,505,248 discloses a method and a system of collecting, monitoring and reporting the performance information of servers located on a network though those servers are not located on the SAN.

### SUMMARY OF THE INVENTION

Even a storage manager has had difficulty in determining if a performance value of a storage resource included in the performance information collected by the conventional method is appropriate. The reasons are as follows.

Reason (1): Depending upon a performance request for processing the operations of a business (often referred simply to as the operation process in noun form), a performance value required for a storage resource is variable. For example, if an I/O operation to and from a storage occupies a high ratio of a processing time of the operation process, the performance requested for the storage becomes higher.

Reason (2): Since the I/O characteristic to the storage is variable depending upon each operation process, it is difficult to obtain a performance value required for a storage resource that meets the performance request for the operation process. For example, a requested performance value for a response performance or a throughput (data amount or I/O times) is variable depending upon a data amount to be treated at one I/O process or access patterns to data areas (random areas or consecutive areas) in plural I/O processes.

Reason (3): If plural kinds of operation processes share the same storage resource, the condition is made more complicated. That is, it is more difficult to determine the appropriate performance value at the current time about a storage resource whose performance is to be monitored because the dynamic change of the configuration of a processing amount of each operation process with time becomes an obstacle to grasping which of the storage resources are currently used by which of the operation processes.

Based on the foregoing reasons, it is difficult to predetermine an appropriate threshold value to be used for predicting and detecting such a performance degrade of a storage as causing the problem on the performance of the operation process in advance by monitoring the performance value of a storage resource. In consideration of the foregoing matters, it is an object of the present invention to properly realize the setting of a threshold to be used for monitoring the performance of a storage resource and the monitoring of the performance thereof in the SAN circumstance where plural storage resources are located.

In carrying out the foregoing the object, the present invention provides a storage management system which is configured to have a host computer, one or more storage devices, a storage network, and a management server as a minimum.

The management server includes a performance information collecting unit that collects a current performance value about a storage resource, a composition section determining unit that determines a composition section for a composition ratio of each of the operation processes, a threshold information storing unit that stores a performance monitoring threshold value for each composition section with respect to one or more previous storage resource, and a performance determining unit that determines the performance of a storage resource based on the current performance value and the performance monitoring threshold. The other means will be described later.

The present invention provides a capability of properly realizing the setting of the performance monitoring threshold and the monitoring of the performance about the storage resources located in the SAN environment with respect to the operation process being in execution.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a basic concept of the present invention;

FIG. 2 is a block diagram showing an overall configuration of a storage system according to an embodiment of the present invention;

FIG. 3 is a block diagram showing a module of a program according to an embodiment of the present invention;

FIG. 4 is a view showing an operation process table provided in application programs according to an embodiment of the present invention;

FIG. 5 is a view showing a relation table between application programs and device files according to an embodiment of the present invention;

FIG. 6 is a view showing a relation table between device files and (WWN, LUN) according to an embodiment of the present invention;

FIG. 7 is a view showing a relation table between logical volumes and (WWN, LUN) according to an embodiment of the present invention;

FIG. 8 is a view showing a relation table between application programs and resources according to an embodiment of the present invention;

FIG. 9 is a view showing an operation process performance table according to an embodiment of the present invention;

FIG. 10 is a view showing a resource performance table according to an embodiment of the present invention;

FIG. 11 is a view showing a table of performances requested by operation processes according to an embodiment of the present invention;

FIG. 12 is a view showing a resource performance monitoring threshold table according to an embodiment of the present invention;

FIG. 13 is a view showing a relation table between performance monitoring thresholds of resources and requested performance unattainableness of operation processes according to an embodiment of the present invention;

FIG. 14 is a view showing an operation process composition section table of resources according to an embodiment of the present invention;

FIG. 15 is a flowchart showing a performance determining process according to an embodiment of the present invention;

FIG. 16 is a flowchart showing a process of determining an operation process composition section according to an embodiment of the present invention;

FIG. 17 is a flowchart showing a process of determining a resource threshold according to an embodiment of the present invention;

FIG. 18 is a flowchart showing a pre-alerting process according to an embodiment of the present invention;

FIG. 19 is a flowchart showing a process of relaxing a performance monitoring threshold according to an embodiment of the present invention;

FIG. 20 is a flowchart showing a process of determining if a performance problem of the operation process is not still detected according to an embodiment of the present invention;

FIG. 21 is a flowchart showing a process of tightening a threshold according to an embodiment of the present invention;

FIG. 22 is an explanatory view showing the process o resetting a performance monitoring threshold according to the present invention; and

FIG. 23 is a chart showing the performance monitored results represented on a time basis according to the present invention.

### DETAILED DESCRIPTION OF THE EMBODIMENTS

Hereafter, at first, the concept of the present invention will be described and then the best modes of carrying out the present invention (referred to as the embodiments) will be described with reference to the appended drawings (and the other drawings if necessary).

(Concept)

In order to overcome the foregoing shortcoming, the present invention properly realizes the monitoring of performance in the SAN environment by the following means.

Means (1): The performance information (including a processing amount such as a response time and execution times) of an operation process to be executed by a storage resource whose performance is to be monitored is collected from an operation server (host computer). Further, the performance requirements for the operation process are pre-set.

Means (2): The performance value of the storage resource appearing when the performance value of the operation process meets or does not meet the predetermined requested performance is specified by using the performance values of the operation processes collected on a time basis and the performance value of the storage resource to be used by the operation process, and then the specified performance value is set to the performance monitoring threshold (often referred simply to as the threshold) of the storage resource.

Means (3) If plural kinds of operation processes share the same storage resource, the processing amount of each operation process that uses the concerned storage resource is searched and then the operation process composition section of the processing amount of plural kinds of operation processes (Operation process composition section) that use the concerned storage resource is determined.

Means (4): For each of the determined composition sections, the performance monitoring threshold of the storage resource in the means (2) is held. Though the setting of the performance monitoring threshold of the storage resource follows the means (2), the performance values of all operation processes that share the concerned storage resource are considered in the setting. Further, when monitoring the performance, it is determined if the current performance value of the storage resource is appropriate by using the performance monitoring thresholds set to the current operation process composition sections.

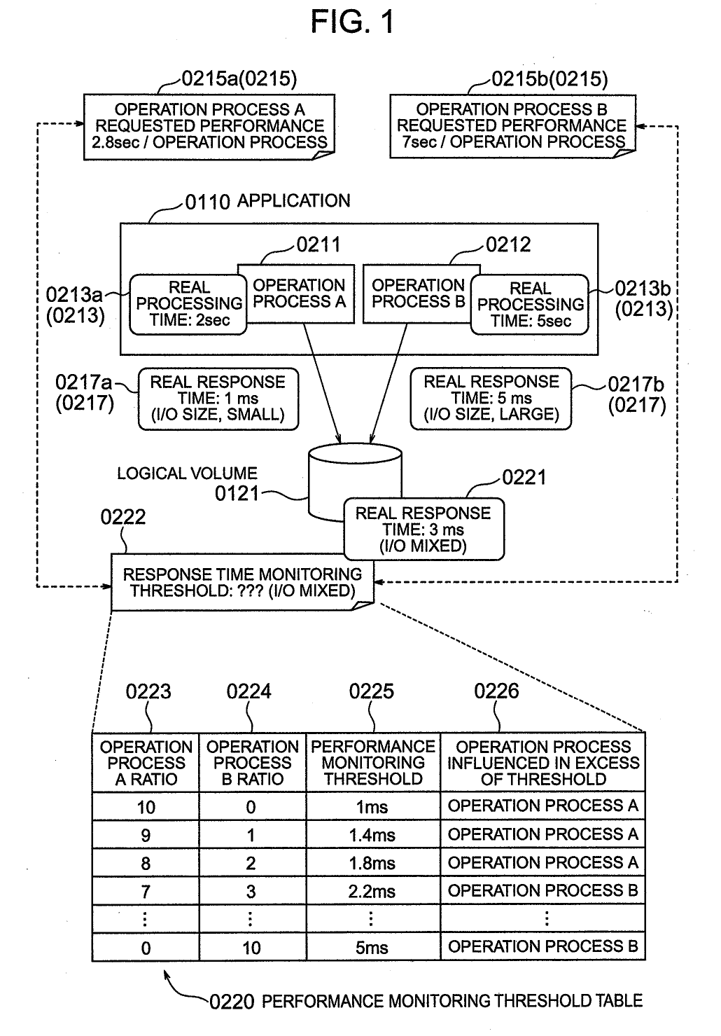

FIG. 1 shows the basic concept of the present invention focused on the foregoing means (3) and (4). At first, the reasons (1) and (2) described in the “Summary of the Invention” will be described with reference to an embodiment.

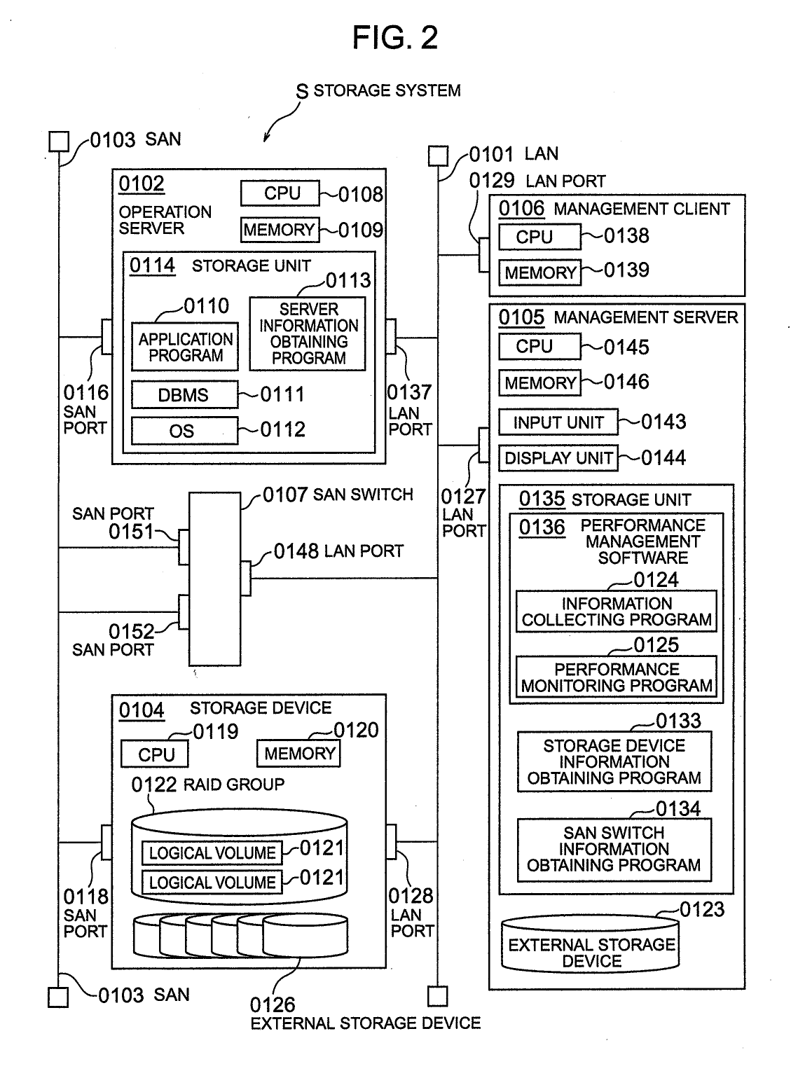

Herein, as shown in FIG. 2, an application program (referred simply to as an application) 0110 is a program that is run in the operation server 0102 so that the program executes the operation process. The program is executed to read and write data from and in a logical volume 0121 that is a storage area of the data in a storage device 0104 if necessary.

Turning back to FIG. 1, the application 0110 is made up of one operation process A0211 and the other operation process B0212. As to the operation process A0211, an operation process requested performance 0215a (0215) per operation process is 2.8 seconds in light of system requirements. Further, the real processing time 0213a (0213) of the operation process A0211 at a time is 2 seconds. During the processing time, the operation process A is executed to input and output data in and from the logical volume 0121. The real response time 0217a (0217) is 1 millisecond.

As to the operation process B0212, the operation process requested performance 0215b (0215) per operation process is 7 seconds in light of system requirements. The real processing time 0213b (0213) of the operation process B0212 at a time is 5 seconds. During the processing time, the operation process B is executed to input and output data in and from the logical volume 0121. The real response time 0217b (0217) is 5 milliseconds.

For example, since the operation process B0212 requests a larger data size of one I/O of the logical volume 0121 than the operation process A0211, the operation process B0212 needs a longer I/O time than the operation process A0211. The difference of the real response time 0217 takes place based on only the I/O characteristics (herein, the data size of one I/O) to the logical volume 0121. It thus does not have any direct relation with the real processing time 0213 of the operation process. Further, it is quite difficult to obtain the data size of an I/O to the storage (logical volume 0121) in the operation process in advance. Moreover, though in this case the performance requested by the storage resource is determined based on only the performance requested by the operation process, this determination is difficult since it greatly depends upon the I/O characteristics of the storage (logical volume 0121), so that the setting of the performance monitoring threshold is also made difficult.

Then, the reason (3) described in the “Summary of the Invention” will be described with reference to the embodiment.

In FIG. 1, the operation processes A0211 and B0212 are executed to input and output data to and from the same logical volume 0121. In this case, the real response time 0221 of the logical volume 0121 is derived as the average response time of the I/Os of these operation processes (Operation processes A and B) at a unit time. Hence, the real response time 0221 of the logical volume 0121 where the I/Os of both the operation processes A0211 and B0212 are carried out is determined by an execution ratio of the operation processes A0211 and B0212 at a unit time and a real response time of the I/O given to the logical volume by each of the operation processes B0211 and B0212. However, the processing amounts of these operation processes A0211 and B0212 are changed on time. It means that it is quite difficult to properly determine the performance monitoring threshold (response time monitoring threshold 0222) of the logical volume 0121.

In order to overcome the shortcoming resulting from the foregoing reason, the present invention provides the following three methods of monitoring the performance of the storage resource.

(a) The first method is provided of determining the performance monitoring threshold by grasping whether or not a system requirement unattainableness of the previous operation process is to be detected in light of the previously monitored operation processes, the performance information of the storage resource, and the system requirement of the operation process.

(b) The second method is provided of setting the performance monitoring threshold to each composition section of the operation process that uses the storage resource.

(c) The third method is provided of selecting the performance monitoring threshold to each composition section of the operation process that uses the storage resource and monitoring the performance based on the threshold.

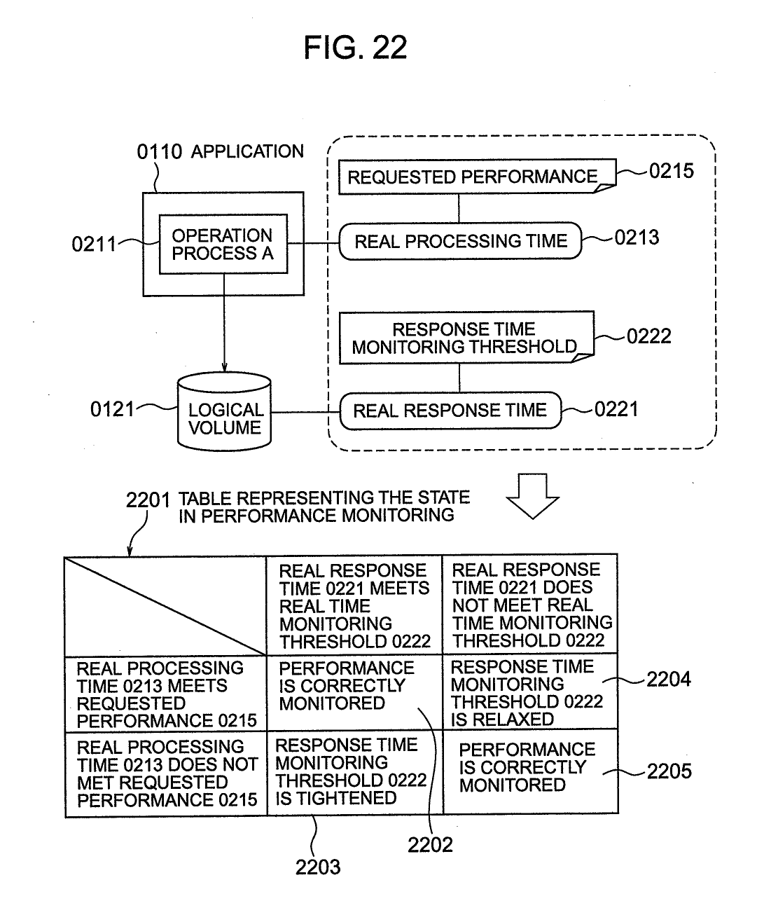

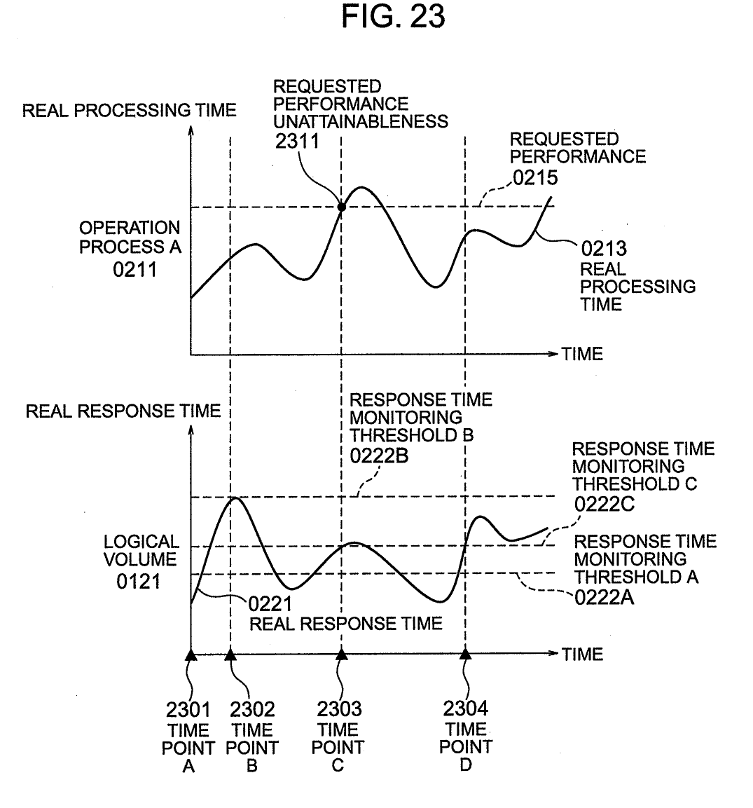

The setting of the performance monitoring threshold in the foregoing methods (b) and (c) of the present invention and the performance monitoring based on the performance monitoring threshold will be concretely described before with reference to FIG. 1. The determination of the performance monitoring threshold in the foregoing first method (a) will be described later with reference to FIGS. 22 and 23. In FIG. 1, the performance monitoring threshold is held in the following form. A performance monitoring threshold table 0220 includes an operation process A ratio 0223 that is the ratio of the processing amount of the operation process A0211 to the overall processing amount, an operation process B0212 ratio 0224 that is the ratio of the processing amount of the operation process B to the overall processing amount, a performance monitoring threshold 0225, and an operation process 0226 influenced when the real performance exceeds the threshold as the columns of the table 0220.

As such, one of the basic ideas of the present invention is the ability of managing the performance monitoring threshold 0225 of the logical volume 0121 changing the composition of the processing amounts of the operation processes in each section (operation process composition section) of the ratio of the processing amount of the operation process A0211 to the operation process B0212. For example, when the ratio of the processing amount of the operation process A0211 to the operation process B0212 is 9:1, the appropriate performance value of the logical volume 0121 is required to be less than 1.4 ms and the performance monitoring threshold 0225 (response time) is 1.4 ms. Likewise, when the ratio of the processing amount is 8:2, the performance monitoring threshold 0225 is 1.8 ms.

Thus, when setting the performance monitoring threshold of the logical volume 0121 (creating the performance monitoring threshold table 0220), the method is executed to search the ratios of the processing amount of the operation processes A0211 and B0212 appearing when the performance monitoring threshold of the operation processes A0211 and B0212 both sharing the logical volume 0121 is determined and then to set the determined performance monitoring threshold 0225 to the concerned ratios. Conversely, monitoring of the performance of the logical volume 0121 is executed to search the current execution ratios of the operation processes A0211 and B0212 sharing the logical volume 0121 and to compare the performance threshold 0225 at the concerned ratios with the real response time 0221 of the logical volume 0121. When the real response time 0221 exceeds the performance monitoring threshold 0225, the fact is reported to a user.

The operation process 0226 influenced in the excess of the threshold represents the operation process where the occurring possibility of an unattainableness is high if the performance of the logical volume 0121 conflicts with the performance monitoring threshold. In the past, if the real operation process performance does not meet the requested performance in any of the operation processes sharing the logical volume 0121, the real response time of the logical volume 0121 at the time is set as the performance monitoring threshold and the operation process the real performance of which does not meet the requested performance is recorded as well. This makes it possible to report the operation process where the performance problem may take place at a higher possibility to the user if the real response performance of the logical volume 0121 does not meet the performance monitoring threshold.

In turn, the first method (a) will be described with reference to FIGS. 22 and 23. To make the description simple, it is assumed that only one operation process accesses the logical volume 0121. In this assumption, the operation process composition section is just one. In the storage system shown in FIG. 22, an application 0110 is made up of the operation process A0211. The operation process that can input and output data to and from the logical volume 0121 is only the process A0211. In light of the system requirements, the requested performance 0215 is requested with respect to the real processing time 0213 of the operation process A0211. As to the real response time 0221 of the logical volume 0121, the response time monitoring threshold 0222 is set in order to monitor the performance on the set threshold. A table 2201 represents the state where the performance is being monitored. The table 2201 represents the relation between the real processing time 0213 and the requested performance 0215 of the operation process A0211 and the relation between the real response time 0221 and the response time monitoring threshold 0222 of the logical volume 0121.

In the table 2201, a cell 2202 designates the case that the real processing time 0213 of the operation process A0211 meets the requested performance 0215 and the real response time 0221 of the logical volume 0121 meets the response time monitoring threshold 0222. Since both are matched to each other, the cell 2202 means that the response time monitoring threshold 0222 of the logical volume 0121 is appropriate (the performance is properly monitored).

A cell 2203 designates the case that the real processing time 0213 of the operation process A0211 does not meet the requested performance 0215 and the real response time 0221 of the logical volume 0121 meets the response time monitoring threshold 0222. It means that the response time monitoring threshold 0222 of the logical volume 0121 is relaxedly set. In the case designated by the cell 2203, the response time monitoring threshold 0222 is required to be severely reset so that the real response time 0221 of the logical volume 0121 does not meet the response time monitoring threshold 0222.

A cell 2204 designates the case that the real processing time 0213 of the operation process A0211 meets the requested performance 0215 and the real response time 0221 of the logical volume 0121 does not meet the response time monitoring threshold 0222. It means that the response time monitoring threshold 0222 of the logical volume 0121 is severely set. In the case designated by the cell 2204, the response time monitoring threshold 0222 is required to be relaxedly reset so that the real response time 0221 of the logical volume 0121 meets the response time monitoring threshold 0222.

A cell 2205 designates the case that the real processing time 0213 of the operation process A0211 does not meet the requested performance 0215 and the real response time 0221 of the logical volume 0121 does not meet the response time monitoring threshold 0222. Since both are matched to each other, it means that the response time monitoring threshold 0222 of the logical volume 0121 is appropriate (the performance is properly monitored).

FIG. 23 is a graph representing the result of monitoring the performance of the storage system shown in FIG. 22 on a time basis. In the two time-series graphs shown in FIG. 23, the upper graph represents the real processing time 0213 of the operation process A, while the lower graph represents the real response time 0221 of the logical volume 0121.

The performance monitoring threshold at a time A2301 was a response time monitoring threshold A0222A. At a time B2302, the real response time 0221 exceeds (does not meet) the response time monitoring threshold A0222A but the real processing time 0213 meets the requested performance 0215. That is, it corresponds to the case of the cell 2204 of the table 2201 and thus the real response time 0221 at the time B2302 is set as the performance monitoring threshold. The response time monitoring threshold B0222B is the performance monitoring threshold set at the time B.

At a time C2303, the real processing time 0213 of the operation process A0211 does not meet the requested performance 0215, so that the requested performance unattainableness 2311 took place. However, the real response time 0221 meets the response time monitoring threshold B0222B. It corresponds to the case of the cell 2202 of the table 2201. Hence, the real response time 0221 at the time C2303 is set as the performance monitoring threshold.

At a time D2304, the real response time 0221 does not meet the response time monitoring threshold C0222C set at the time C2303 and the requested performance 0215 meets the real processing time 0213. It corresponds to the case of the cell 2204 of the table 2201. However, since the response time monitoring threshold 0222 was once made severe at the time C2303, the response time monitoring threshold 0222 is not relaxed (may be relaxed). As in this case, the present invention provides a capability of relaxing or tightening the performance monitoring threshold so as to (dynamically) set an appropriate performance monitoring threshold.

### EMBODIMENTS

Hereafter, the embodiments of the present invention will be described in detail with reference to the drawings.

FIG. 2 shows the overall configuration of the storage system according to an embodiment of the present invention. A storage system S (storage management system) is configured of an operation server 0102, a storage device 0104, a management server 0105, a management client 0106 and an SAN switch 0107. The operation server 0102 is connected with the storage device 0104 through the SAN 0103 (storage network). Further, the operation server 0102, the storage device 0104, the management server 0105 and the management client 0106 are connected with one another through an LAN (Local Area Network) 0101.

In turn, the description will be oriented to the arrangement of the operation server 0102. The storage system S shown in FIG. 2 is made up of one operation server 0102. In actual, however, it may be made up of two or more operation servers 0102. The operation server 0102 is dedicated to running an application 0110 and provides a CPU (Central Processing Unit) 0108 and a memory 0109. The operation server 0102 includes an SAN port 0116 and is connected with the SAN 0103 through the SAN port 0116. Further, the operation server 0102 includes an LAN port 0137 through which the operation server 0102 is connected with the LAN 0101.

The CPU 0108 executes various kinds of processes by reading programs stored in a storage unit 0114 and moving and executing them on a memory 109. In the following description, to make the description simple, not the CPU 0108 but each program itself may be described as the operating entity. The memory 0109 is an operating area of the CPU 0108. The storage unit 0114 saves the application 0110, a database management software program (referred to as a DBMS (Database Management System)) 0111, an OS (Operating System) 0112 and a server information obtaining program 0113.

The application 0110 is a program that executes the operation process. It requests the DBMS 0111 of addition or reference of data in accordance with the operation process to be executed. In response to the request given by the application 0110, the DBMS 0111 is executed to define or handle the data stored in the storage device 0104. The server information obtaining program 0113 is executed to collect information about the operation process to be executed by the application 0110, the DBMS 0111, the OS 0112 and the SAN port 0116 and then send the obtained information to the management server 0105.

In turn, the arrangement of the storage device 0104 will be described in detail. The storage system S shown in FIG. 2 is made up of one storage device 0104. However, it may be made up of one or more storage devices 0104. The storage device 0104 includes a CPU 0119, a memory 0120 and a logical volume 0121. The storage device 0104 includes an SAN port 0118 through which the storage device 0104 is connected with an SAN 0103. Further, the storage device 0104 includes an LAN port 0128 through which it is connected with an LAN 0101.

The CPU 0119 and the memory 0120 control an I/O of data to and from the storage device 0104 as well as collects the management information about the CPU 0119, the memory 0120 and the logical volume 0121 and sends the management information to the management server 0105. The memory 0120 provides a (caching) function of temporarily storing data, the data being basically inputted in or outputted from the storage device 0104.

The logical volume 0121 is a storage area of data in the storage device 0104. The data is read from or written in the logical volume 0121 at a block unit. In actual, the logical volume 0121 is composed of a RAID (Redundant Arrays of Inexpensive Disks) group 0122 made up of one or more external storage devices 0126. The logical volume 0121 is made up of one or more logical storage areas, that is, logical volumes. The external storage device 0126 may be a FC (Fibre Channel) disk or the like.

In turn, the arrangement of the SAN switch 0107 will be described in detail. The storage system S shown in FIG. 2 is made up of one SAN switch 0107. However, it may be made up of two or more SAN switches 0107. The SAN switch 0107 is served as a networking device for relaying data being communicated between the operation server 0102 and the storage device 0104 and includes SAN ports 0151 and 0152. The SAN switch 0107 includes an LAN port 0148 through which it is connected with the LAN 0101.

In turn, the arrangement of the management server 0105 will be described in detail.

The management server 0105 is arranged to have a CPU 0145, a memory 0146, an input unit 0143, a display unit 0144, a storage unit 0135 and an external storage device 0123. The management server 0105 includes an LAN port 0127 through which it is connected with the LAN 0101.

The CPU 0145 executes various kinds of processes by reading programs stored in the storage unit 0135, moving them in the memory 0146, and executing them. Further, the CPU 0145 operates to display on the display unit 0144 the information with which a user interacts while various kinds of process are being executed. The CPU 0145 operates to process the information entered on the input unit 0143 through the interaction with the user.

The storage unit 0135 stores the performance management software 0136, a storage device information obtaining program 0133 and an SAN switch information obtaining program 0134. The external storage device 123 stores the information to be collected and managed by the performance management software 0136 to be discussed below.

The performance management software 0136 is composed of an information collecting program 0124 and a performance monitoring program 0125. The information collecting program 0124 is executed to receive the management information sent from the server information obtaining program 0113, the storage device information obtaining program 0133 and the SAN switch information obtaining program 0134 and then to put the obtained management information in the external storage device 0123. Further, the performance monitoring program 0125 has a function of setting a performance monitoring threshold to an object to be monitored based on the management information stored in the external storage device 0123, a function of monitoring the performance based on the performance monitoring threshold, and a function of notifying a management client 0106 of a disadvantage occurring or possibly occurring in the performance if any.

The storage device information obtaining program 0133 is executed to obtain the information to be discussed below from the storage device 0104 and then send the information to the information collecting program 0124. The SAN switch information obtaining program 0134 is executed to obtain the information to be discussed below from the SAN switch 0107 and then send the information to the information collecting program 0124.

In turn, the arrangement of the management client 0106 will be described in detail. The storage system S shown in FIG. 2 is made up of one management client 0106. In actual, it may be made up of two or more management clients 0106. The management client 0106 is a device for providing a user interface of the management server 0105 and includes a CPU 0138 and a memory 0139. The management client 0106 has an LAN port 0129 through which it is connected with the LAN 0101.

The CPU 0138 operates to convey the information of the management client 0106 stored in the memory 0139 to a user. For example, the CPU 0138 causes the Web browser to be active so that the user interface may appear on the display. The memory 0139 stores the information of the management client 0106 and the information about the software for providing the user interface.

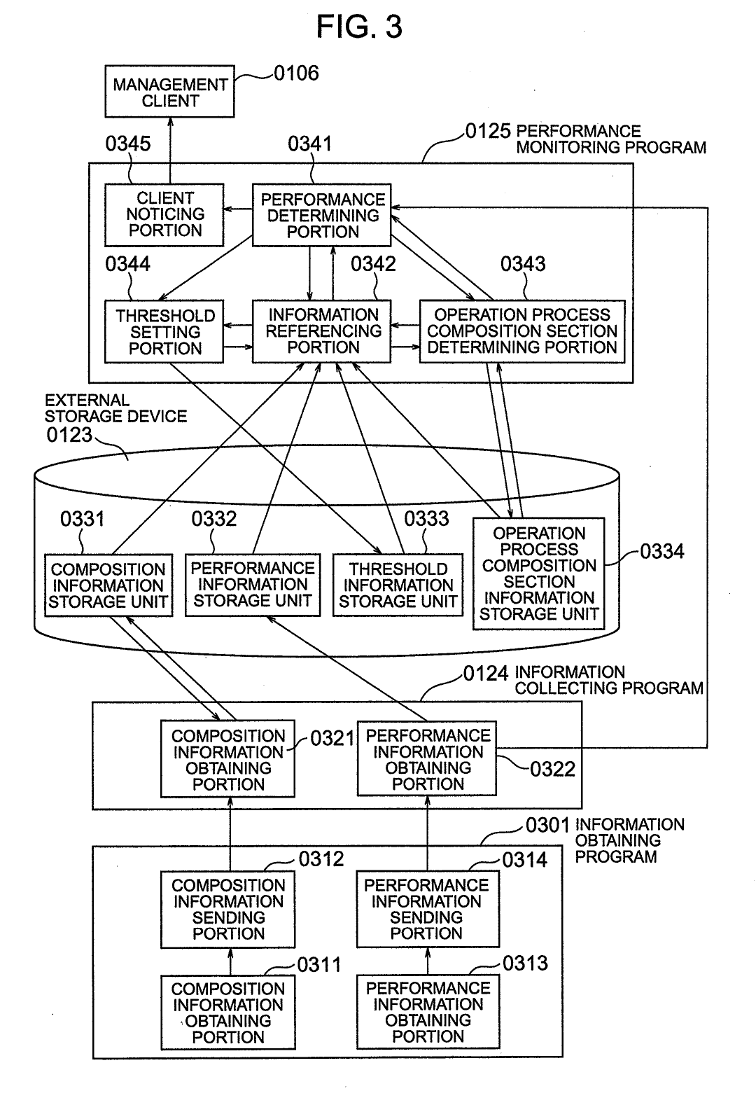

FIG. 3 shows a module arrangement of the program according to the embodiment of the invention. The roles of the program modules according to this embodiment will be described with reference to FIG. 3.

The information obtaining program 0301 is a program for collecting information an object to be monitored in the storage system S. The program 0301 includes a composition information obtaining portion 0311, a composition information sending portion 0312, a performance information obtaining portion 0313 (performance information collecting portion), and a performance information sending portion 0314. Further, the information obtaining program 0301 represents a common composition to the server information obtaining program 0113, the storage device information obtaining program 0133 and the SAN switch information obtaining program 0134, the three programs being shown in FIG. 2. In the information obtaining program 0301, the method of obtaining information and the method of sending the information are different depending upon the target device from which the information is to be obtained.

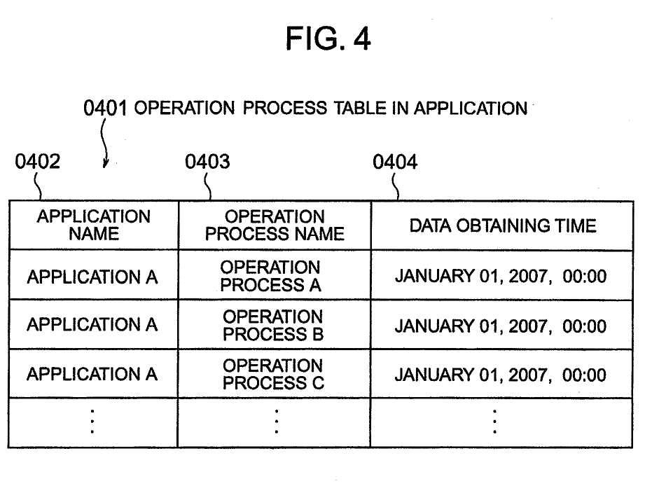

The composition information obtaining portion 0311 is invoked by the scheduling function set in the information obtaining program 0301 and starts the process. After being invoked, the obtaining portion 0311 is executed to obtain the composition information from the device to be monitored and then pass the composition information to the composition information sending portion 0312. Herein, the device to be monitored designates the operation server 0102, the storage device 0104 and the SAN switch 0107 shown in FIG. 2. The details of the composition information obtained from the device to be monitored will be described with reference to FIGS. 4 to 7.

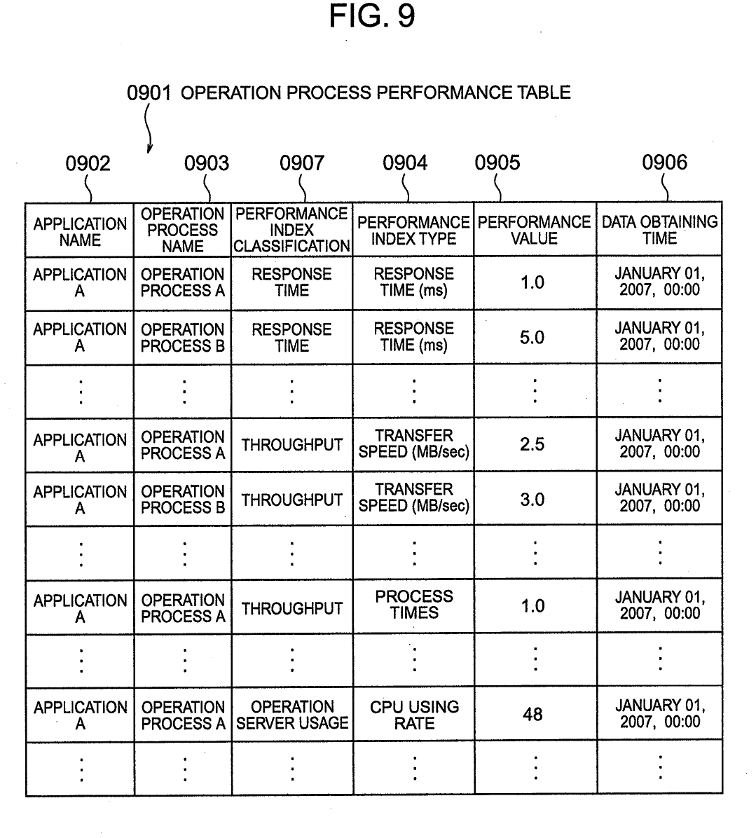

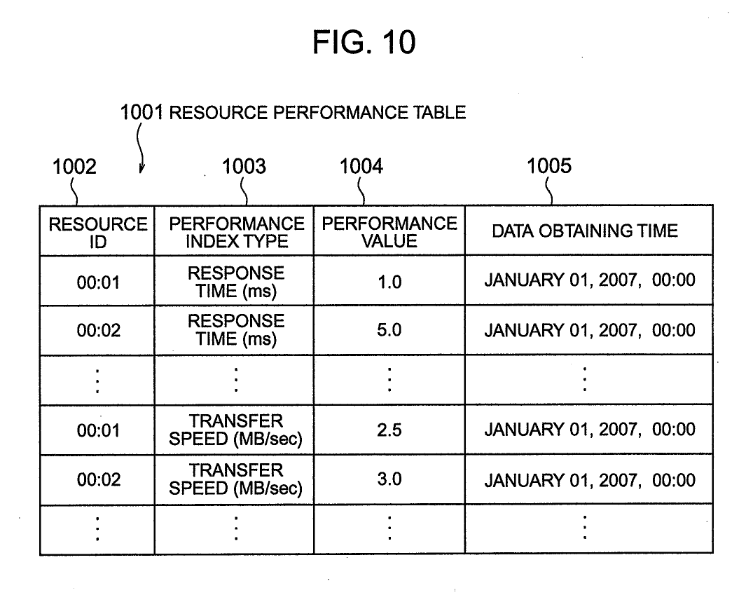

The composition information sending portion 0312 is executed to send the data passed from the composition information obtaining portion 0311 to the composition information obtaining portion 0321 of the information collecting program 0124. The performance information obtaining portion 0313 is invoked by the scheduling function set in the information obtaining program 0301 and then starts the process. After being started, the performance information obtaining portion 0313 is executed to obtain the performance information of the device to be monitored and then pass the performance information to the performance information sending portion 0314. The device to be monitored in the sending portion 0312 is the same as that in the composition information obtaining portion 0311. Further, the details of the performance information to be obtained will be described later with reference to FIGS. 9 and 10.

The performance information sending portion 0314 is executed to send the data passed from the performance information obtaining portion 0313 to a performance information obtaining portion (performance information collecting portion) 0322 of the information collecting program 0124. As such, the information collecting program 0124 includes the composition information obtaining portion 0321 and the performance information obtaining portion 0322 and is executed to store the information collected, by the information obtaining program 0301, from each device to be monitored in the storage unit of the external storage device 0123.

The external storage device 0123 includes a composition information storage unit 0331, a performance information storage unit 0332, a threshold information storage unit 0333, and an operation process composition section information storage unit 0334. The composition information obtaining portion 0321 of the information collecting program 0124 is executed to store the composition information of each device to be monitored, received from the information obtaining program 0301 in the composition information storage unit 0331, retrieve the relation with the application using the storage resource on the basis of the stored composition information, and then store the retrieved result in the composition information storage unit 0331.

The performance information obtaining portion 0322 is executed to store the performance information of each device to be monitored, received from the information obtaining program 0301, in the performance information storage unit 0332 and then, after the information is stored, start a performance determining portion 0341 of the performance monitoring program 0125. The details of the performance information to be stored in the performance information storage unit 0332 will be described later with reference to FIGS. 9 and 10. The performance monitoring program 0125 includes the performance determining portion 0341, an information referencing portion 0342, an operation process composition section determining portion (composition section determining portion) 0343, a threshold setting portion 0344, and a client noticing portion 0345. The performance monitoring program 0125 provides the functions of setting the performance monitoring threshold, determining the performance based on the performance monitoring threshold and the performance information, and noticing facts such as occurrence of a disadvantage to a client.

The performance determining portion 0341 is started by the performance information obtaining portion 0322 so that the portion 0341 may determine if a problem takes place in the performance of the storage resource by using the performance monitoring threshold corresponding with the current operation process composition section. Further, the performance determining portion 0341 is executed to notice the determined result to the client noticing portion 0345 if necessary and, in the case of setting the performance monitoring threshold, invoke the threshold setting portion 0344. The performance determining portion 0341 invokes the operation process composition section determining portion 0343 so that the performance determining portion 0341 can obtain the information of the operation process composition section from the determining portion 0343. Moreover, the performance determining portion 0341 is executed to obtain the performance information of the storage resource and the performance monitoring threshold corresponding with the current operation process composition section of the storage resource from the information reference portion 0342.

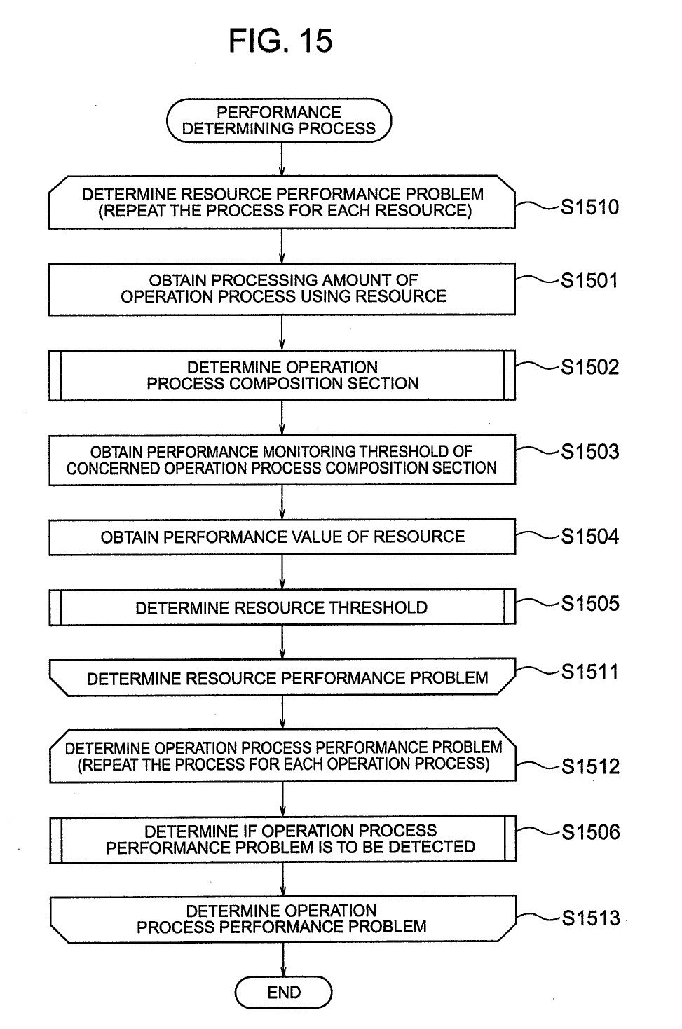

The performance determining portion 0341 is executed to determine the performance based on the information obtained from the information reference portion 0342 and the operation process composition section determining portion 0343. If it is determined that a problem on the performance exists or possibly take place, the performance determining portion 0341 is executed to invoke the client noticing portion 0345 and then notice the determined result to the client. If the performance monitoring threshold is not set or it is required to be modified, the performance determining portion 0341 is also executed to invoke the threshold setting portion 0344 so as to set the performance monitoring threshold. The details of the determining process will be described later with reference to FIGS. 15 to 21.

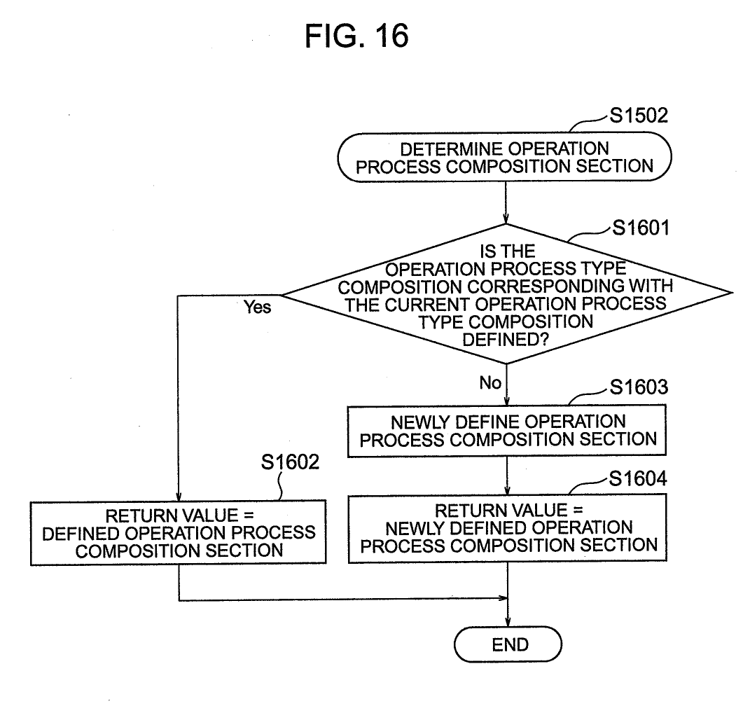

The information referencing portion 0342 is invoked by the performance determining portion 0341, the operation process composition section determining portion 0343, and the threshold setting portion 0344 and is executed to obtain the information from the composition information storage unit 0331, the performance information storage unit 0332, and the threshold information storage unit 0333. The details of the information to be obtained will be described later. The operation process composition section determining portion 0343 is invoked by the performance determining portion 0341 and is executed to determine the operation process composition section according to the processing amount of the operation process that uses the storage resource. The operation process composition section determining portion 0343 is executed to obtain the processing amount of the operation process that uses the storage resource from the information referencing portion 0342. The details of the operation process composition section determining portion 0343 will be described later with reference to FIG. 16.

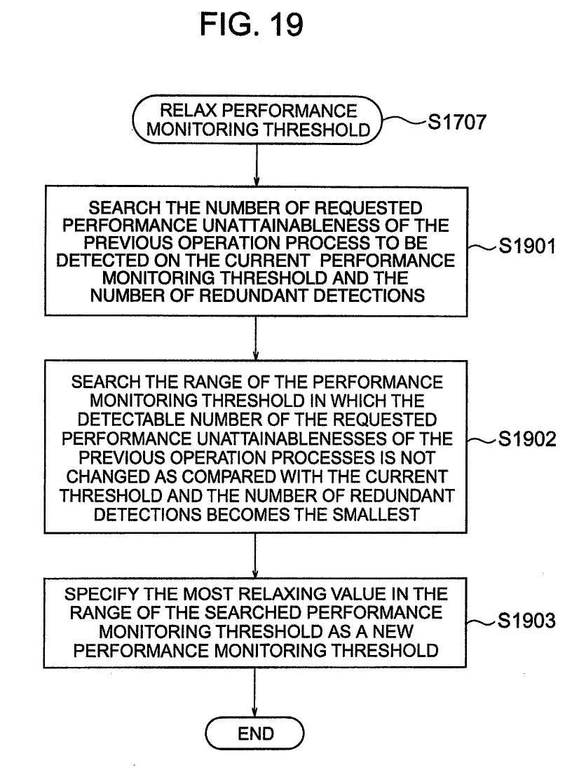

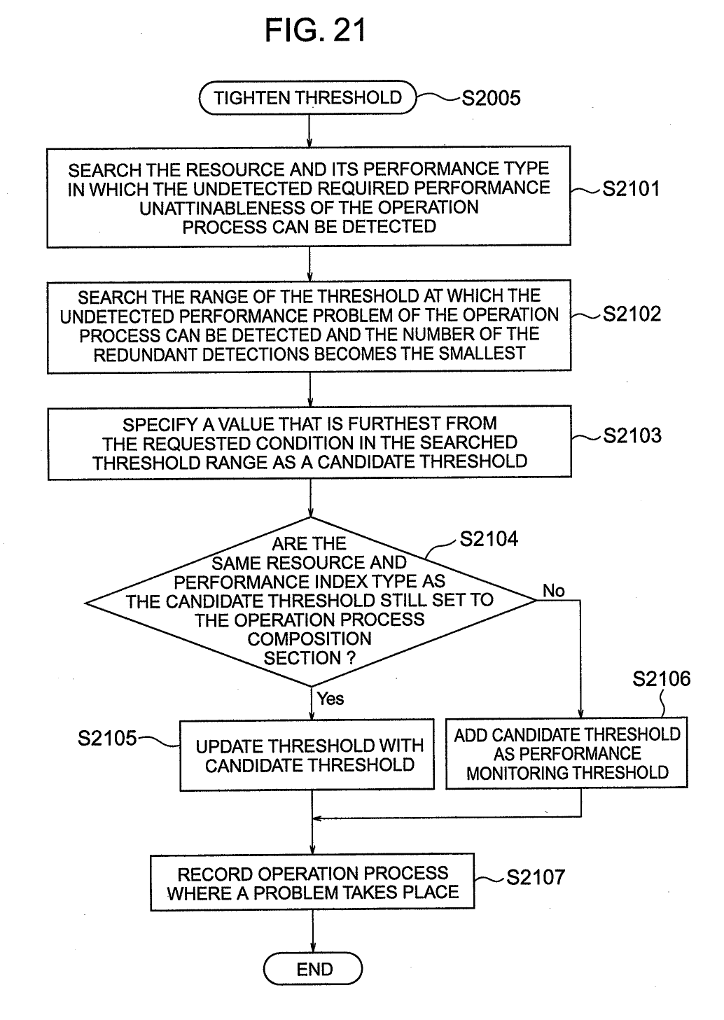

The threshold setting portion 0344 is invoked by the performance determining portion 0341 and is executed to set the performance monitoring threshold corresponding with the operation process composition section of the storage resource. The details of the threshold setting portion 0344 will be described later with reference to FIGS. 19 and 21. The client noticing portion 0345 is invoked by the performance determining portion 0341 and is executed to notice the fact that a problem on the performance took place or the possibility that a problem may take place to the management client 0106. The management client 0106 is executed to receive the information noticed from the client noticing portion 0345 and to present the user with the information through the user interface (display unit or the like).

The external storage device 0123 provides a function of storing information and a function of reading out the stored information. The composition information storage unit 0331 provides a function of storing the composition information in response to an indication given from the composition information obtaining portion 0321 and a function of reading out the composition information. The composition information storage unit 0331 also has a function of reading the composition information out of the information referencing portion 0342. The details of the information to be stored in the composition information storage unit 0331 will be described later with reference to FIGS. 4 to 8.

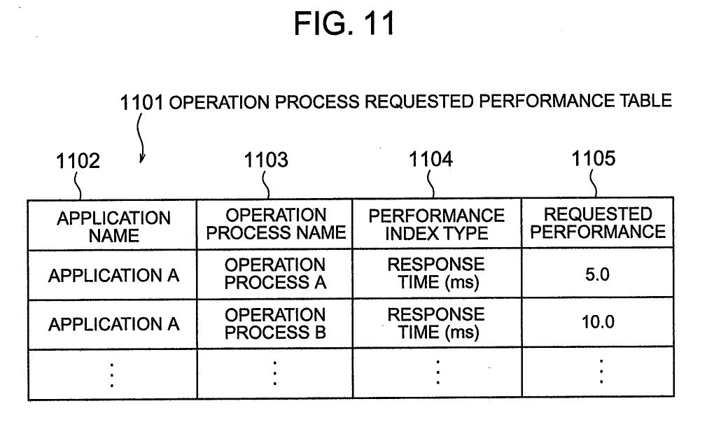

The performance information storage unit 0332 provides a function of storing the performance information in response to an indication given from the performance information obtaining portion 0322 and a function of reading out the performance information in response to an indication given from the information referencing portion 0342. The details of the information to be stored in the performance information storage unit 0332 will be described later with reference to FIGS. 9 and 10. The threshold information storage unit 0333 provides a function of storing the performance monitoring threshold in response to an indication given from the threshold setting portion 0344 and a function of reading out the performance monitoring threshold in response to an indication given from the information referencing portion 0342. The details of the information to be stored in the threshold information storage unit 0333 will be described later with reference to FIGS. 11 to 13.

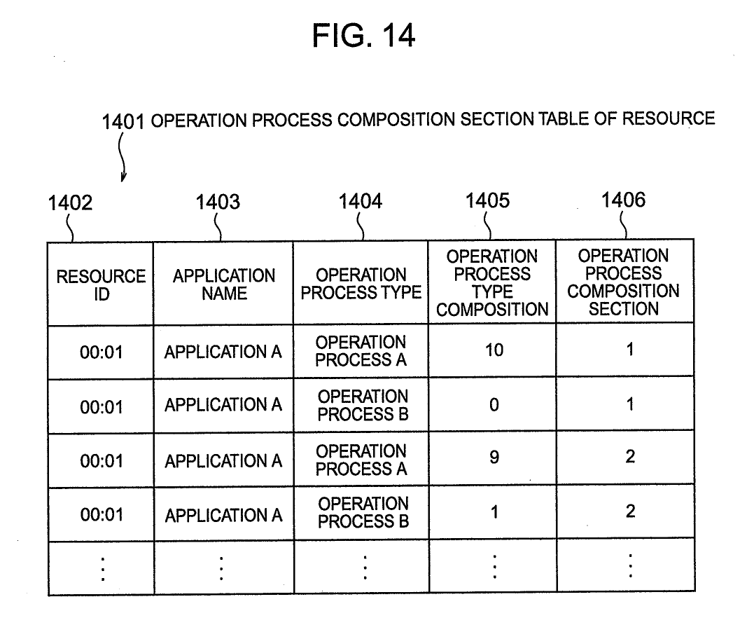

The operation process composition section information storage unit 0334 provides a function of storing and reading out a section corresponding with the operation process composition related with the storage resource in response to an indication given from the operation process composition section determining portion 0343. The details of the information to be stored in the storage unit 0334 will be described later with reference to FIG. 14.

FIG. 4 shows an operation process table 0401 of applications in which the applications and the operation processes therefor are listed. The operation process table 0401 includes an application name 0402, an operation process name 0403, and a data obtaining time 0404 as the columns. The information listed in the operation process table 0401 are obtained and stored through a passage of the application 0110 to the composition information obtaining portion 0311 to the composition information sending portion 0312 to the composition information obtaining portion 0321 to the composition information storage unit 0331.

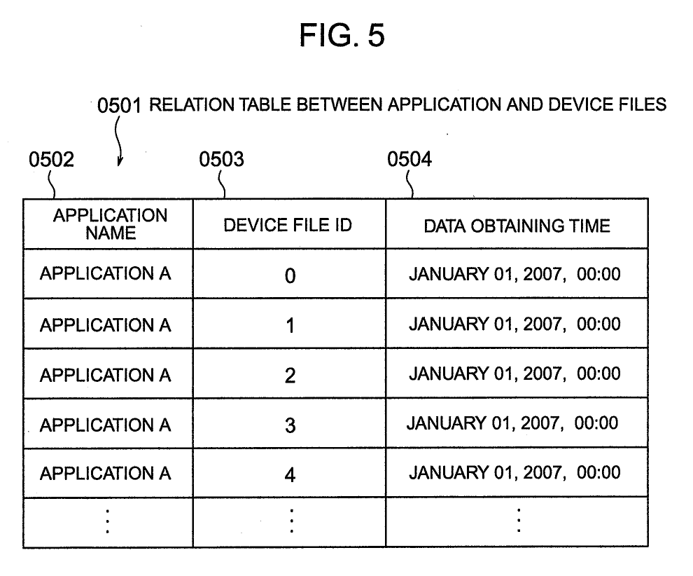

FIG. 5 shows a relation table 0501 between the applications and the device files in which table the relations between the applications and the device files for these applications are listed. The table 0501 includes an application name 0502, a device file ID (IDentification) 0503, and a data obtaining time 0504 as the columns. The information of the relation table 0501 between the applications and the device files is obtained and stored through a passage of the application 0110 and the DBMS 0111 to the composition information obtaining portion 0311 to the composition information sending portion 0312 to the composition information obtaining portion 0321 to the composition information storage unit 0331. Further, the mapping of the applications on the device files is created by the composition information obtaining portion 0311 based on the composition information collected from the application 0110 and the DBMS 0111 by the server information obtaining program 0113.

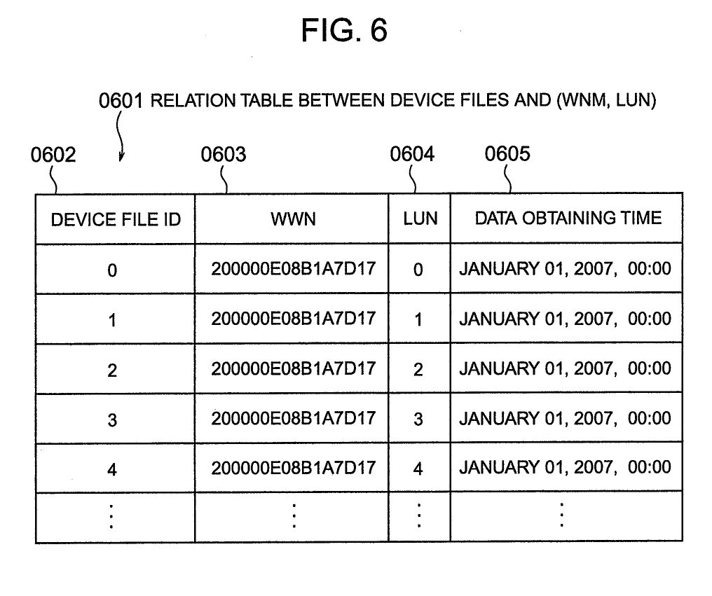

FIG. 6 shows a relation table 0601 between the device files and (WWN, LUN) in which table the relation between WWN (World Wide Name) and LUN (Logical Unit Number) is listed. The relation table 0601 includes the device file ID 0602, the WWN 0603, the LUN 0604, and the data obtaining time 0605 as the columns. The information of the relation table 0601 between the device file and (WWN, LUN) is obtained and stored through a passage of the OS 0112 to the composition information obtaining portion 0311 to the composition information sending portion 0312 to the composition information obtaining portion 0321 to the composition information storage unit 0331.

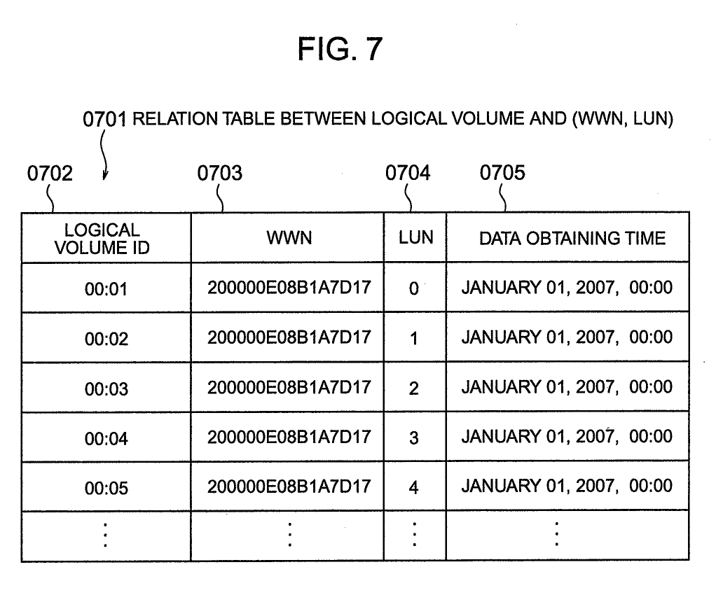

FIG. 7 shows a relation table 0701 that represents the relation between the logical volume 0121 and (WWN, LUN). This relation table 0701 includes a logical volume ID 0702, a WWN 0703, a LUN 0704, and a data obtaining time 0705 as the columns. The information of the relation table 0701 between the logical volume and (WWN, LUN) is obtained and stored through a passage of the storage device 0104 to the composition information obtaining portion 0311 to the composition information sending portion 0312 to the composition information obtaining portion 0321 to the composition information storage unit 0331.

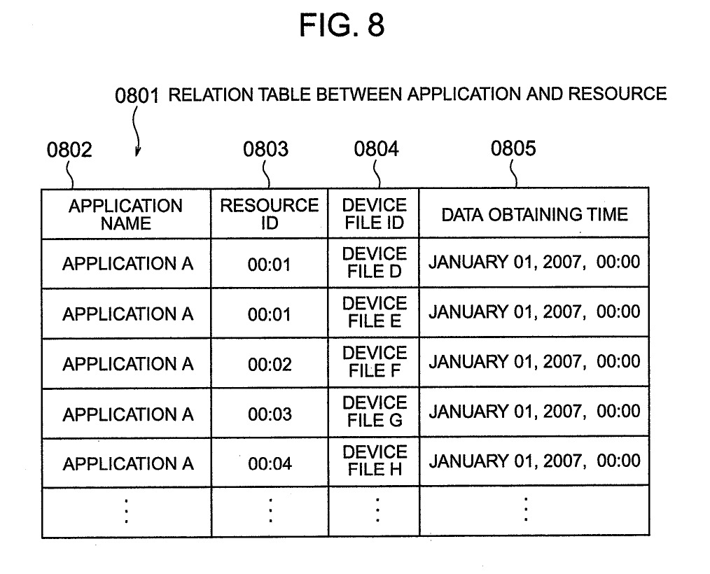

FIG. 8 shows a relation table 0801 between the application and the resource in which table the relations between the applications and the storage resources used by the applications are listed. The relation table 0801 includes an application name 0802, a resource ID 0803, a device file ID 0804, and a data obtaining time 0805 as the columns. In FIG. 8, the logical volumes are shown as the resources. The composition information obtaining portion 0321 is executed to obtain the information shown in FIGS. 5 to 7 from the composition information storage unit 0331, work the information, and then store the worked information in the composition information storage unit 0331.

FIG. 9 shows an operation process performance table 0901 in which a type of a performance value and the performance value itself for each operation process of the application 0110 are listed. The table 0901 includes an application name 0902, an operation process name 0903, a performance index classification 0907, a performance index type 0904, a performance value 0905, an a data obtaining time 0906 as the columns. The performance value stored in the table 0901 is specified as the processing amount (that is, the performance value to be used for calculating the operation process composition section) or the performance requested by the operation process. Whether or not the performance value may be specified as the processing amount or the performance requested by the operation process depends upon the performance index classification 0907 of the performance value.

The performance index classification 0907 has three classes of “response time”, “throughput” and “operation server usage”. Each class has the corresponding performance index type 0904. The performance index classification 0907 to be specified as the processing amount is the throughput and the operation server usage. The performance index classification 0907 to be specified as the performance requested by the operation process is the response time, the throughput, and the operation server usage. The performance index type 0904 of each performance index classification 0907 will be described below.

When the performance index classification 0907 is the response time, the corresponding performance index type 0904 is a response time (per operation process). When the performance index classification 0907 is the throughput, the performance index type 0904 is a transfer speed and times of processes (that is, the number of executions at a unit time of the operation process). When the performance index classification 0907 is the operation server usage, the corresponding performance index type 0904 is a CPU using time, a CPU using ratio, a memory using ratio, a CPU queue length (that is, the number of threads in a CPU queue), and so forth. The information obtained by the server information obtaining program 0113 is filled in the table 0901. The information is obtained and stored in the table through a passage of the application 0110 to the performance information obtaining portion 0313 to the performance information sending portion 0314 to the performance information obtaining portion 0322 to the performance information storage unit 0332.

FIG. 10 shows a resource performance table 1001 in which a performance type and a performance value for a storage resource are listed. The resource performance table 1001 includes a resource ID 1002, a performance index type 1003, a performance value 1004, and a data obtaining time 1005 as the columns. The information obtained by the information obtaining program 0301 is filled in the resource performance table 1001 and is stored through a passage of each device to be monitored to the performance information obtaining portion 0313 to the performance information sending portion 0314 to the performance information obtaining portion 0322 to the performance information storage unit 0332.

FIG. 11 shows an operation process requesting performance table 1101 in which system requirements are listed for the operation processes of the applications. The table 1101 includes an application name 1102, an operation process name 1103, a performance index type 1104, and a requested performance 1105 as the columns. The operation process requesting performance table 1101 shows information on which the performance requested by the operation process is obtained from the application 0110 when the server information obtaining program 0113 is started, is filled in the table 1101 and the information is stored in the threshold information storage unit 0333.

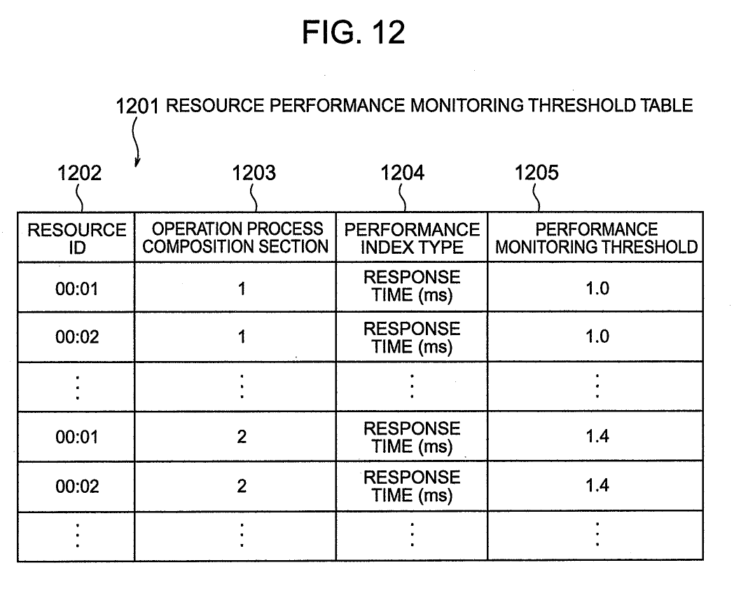

FIG. 12 shows a resource performance monitoring threshold table 1201 in which are listed the performance monitoring thresholds corresponding with the operation process composition sections of the storage resource. The table 1201 includes a resource ID 1202, an operation process composition section 1203, a performance index type 1204, and a performance monitoring threshold 1205 as the columns. In the table 1201, the performance monitoring thresholds filled in the table 1201 are stored in the threshold information storage unit 0333 invoked by the threshold setting portion 0344. Here, the performance monitoring thresholds are used for detecting that the system requirements for the previous operation processes are not met by monitoring the performance of the storage resource. The determination of the performance monitoring threshold will be described below in detail with reference to FIGS. 19 and 21.

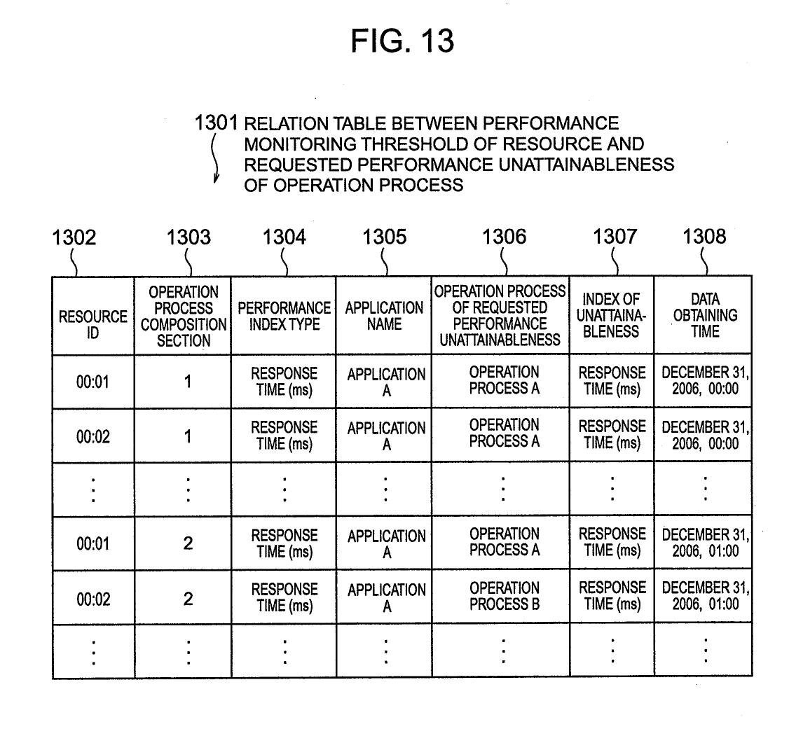

FIG. 13 is a table 1301 of relation (referred simply to as the relation table 1301) between the performance monitoring threshold of the resource and the operation process of the requested performance unattainableness in which table listed are the operation processes with a high possibility of the requested performance unattainableness, caused in the case of detecting a performance monitoring threshold unattainableness in a certain operation process composition section of the resource. The relation table 1301 includes a resource ID 1302, an operation process composition section 1303, a performance index type 1304, an application name 1305, an operation process of a requested performance unattainableness 1306, an index of unattainableness 1307, and a data obtaining time 1308 as the columns. The detection or the detecting possibility of the fact that an operation process did not meet the requested system performance at a time in the past is filled in the relation table 1301. The relation table 1301 is stored in the threshold information storage unit 0333 invoked by the threshold setting portion 0344.

FIG. 14 shows a resource operation process composition section table 1401 in which listed are the compositions of the operation processes in the operation process composition section of the resource. The table 1401 includes a resource ID 1402, an application name 1403, an operation process type 1404, an operation process type composition 1405, and an operation process composition section 1406 as the columns. The table 1401 has the composition sections of the operation process that used the resource at a time in the past. The table is stored in the operation process composition section information storage unit 0334 invoked by the operation process composition section determining portion 0343.

FIG. 15 is a flowchart showing an overall process of setting the performance monitoring threshold and monitoring the performance based on the threshold. This process is executed by the performance monitoring program 0125. In particular, the performance determining portion 0341 mainly controls the overall flow of process.

At first, the performance determining portion 0341 is executed to invoke the operation process composition section determining portion 0343 so as to obtain the operation process composition section of the resource. The determining portion 0343 is executed to obtain the processing amount of each operation process using the resource (step S1501). In step S1501, the application related with the resource is searched in light of the relation table 0801 between the application and the resource. Then, the operation process to be executed by the application is searched in light of the operation process table 0401 of the application. The application and the processing amount of the operation process executed by the application are obtained from the operation process performance table 0901. As described above, the processing amount means a throughput or an operation server usage in the performance index classification 0907 of the operation process performance table 0901.

Then, the operation process composition section determining portion 0343 is executed to determine the operation process composition section through the use of the processing amount of the operation process obtained in the step S1501 (step S1502). Then, the determining portion 0343 is further executed to obtain the operation process composition section and then pass the obtained composition section to the performance determining portion 0341. The detailed procedure of the step S1502 will be described later with reference to FIG. 16. The performance determining portion 0341 is executed to obtain the performance monitoring threshold corresponding with the operation process composition section obtained in the step S1502 (step 1503). In the step S1503, the performance monitoring threshold with the resource ID being equal to (matched to) the operation process composition section is obtained from the resource performance monitoring threshold table 1201 through the use of the information reference portion 0342.

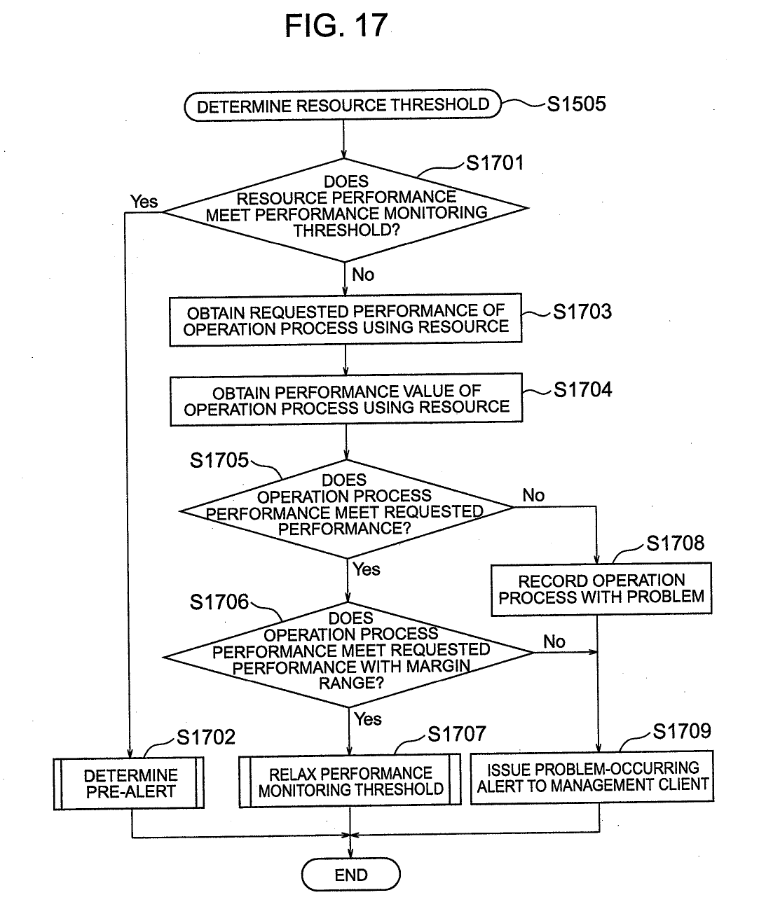

The performance determining portion 0341 is executed to obtain the performance value of the resource through the use of the information reference portion 0342 (step S1504). In this step S1504, the performance values of the resources with the same resource ID are obtained from the resource performance table 1001 through the use of the information referencing portion 0342. The performance determining portion 0341 is executed to determine the resource threshold (step S1505) through the use of the performance monitoring threshold and the performance value obtained in the steps S1503 and S1504. The detailed procedure of the step S1505 will be described below with reference to FIG. 17. The process from the steps S1501 to S1505 is executed for each resource (steps S1510 to S1511).

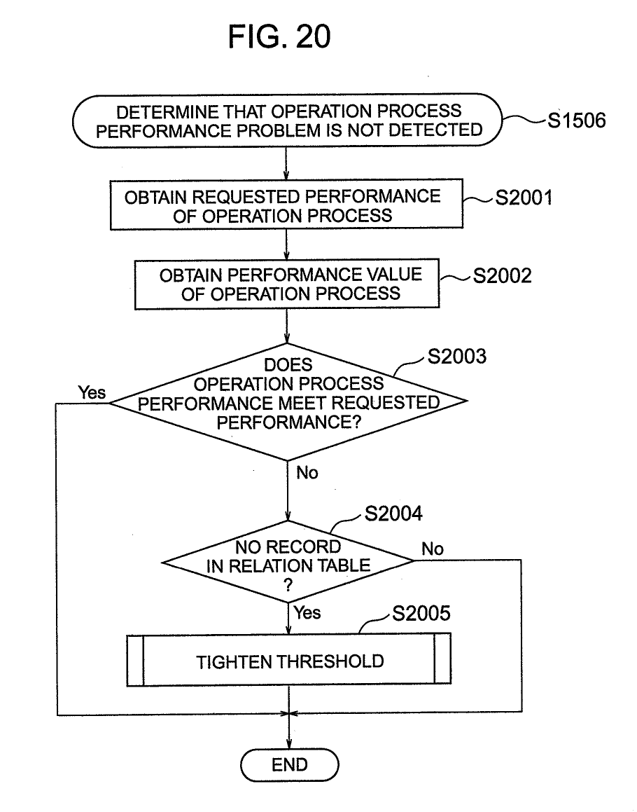

The performance determining portion 0341 is executed to determine if a problem on the performance of the operating process is detected (step S1506). The process of the step S1506 is executed to set the performance monitoring threshold in order to allow the unattainableness of the operation process requesting performance that cannot be detected through the performance monitoring threshold of the resource to be detected. The detailed procedure of the step S1506 will be described later with reference to FIG. 20. The performance determining portion 0341 performs the process of the step S1506 for each operation process (steps S1512 and S1513).

FIG. 16 shows the process (step S1502) of determining the current operation process composition section based on the processing amount of the operation process using the resource, the process being executed by the operation process composition section determining portion 0343. The determining portion 0343 is executed to derive the operation process type composition from the processing amount of the operation process obtained in the step S1501 and then obtain the concerned operation process composition section from the operation process type composition. In order to derive the operation process type composition for determining the operation process composition section, there have been proposed a method of determining it based on an absolute magnitude of each operation process type or a method of determining it based on a ratio of a processing amount of each operation process type. In this embodiment, the ratio of the processing amount is used for that purpose.

The operation process composition section determining portion 0343 is executed to search if the same operation process type composition as the derived composition is defined on the operation process composition section table 1401 of the resource through the use of the information referencing portion 0342 (step S1601). In this step S1601, if the same operation process type composition is defined (Yes), the concerned operation process composition section 1406 of the table 1401 is set to a return value of the operation process composition section determining process (step S1502). This setting process is performed in a step S1602.

In the step S1601, if the same operation process type composition is not defined (No), the operation process composition section determining portion 0343 is executed to newly define the derived operation process type composition and the operation process composition section corresponding therewith in the operation process composition section table 1401 of the resource (step S1603). In this step S1603, the operation process composition section newly defined in the step S1603 is set to a return value of the operation process composition section determining process (step S1502). This setting process is performed in step S1604. Then, the operation process composition section having been set to the return value in the step S1602 or S1604 is given back as a return value to the performance determining portion 0341. Then, the operation process composition section determining process (step S1502) is finished.

FIG. 17 shows the process of determining a resource threshold (step S1505). The process is executed to determine if a problem occurrence alert is notified to the management client 0106 or the performance monitoring threshold is relaxed by comparing the performance of the resource with the threshold of the current operation process composition section.

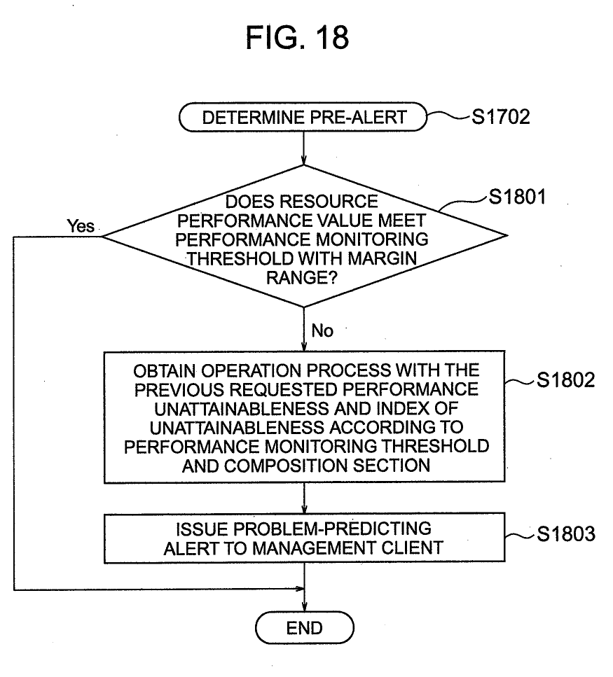

The performance determining portion 0341 is executed to compare the performance monitoring threshold obtained in the step S1503 with the performance of the resource obtained in the step S1504 and determine if the performance of the resource meets the performance monitoring threshold based on the compared result (step S1701). If in the step S1701 the performance of the resource meets the performance monitoring threshold (Yes), the performance determining portion 0341 performs the process of determining a pre-alert (step S1702). The detailed procedure of the pre-alert determining process (step S1702) will be described later with reference to FIG. 18.

If in the step S1701 the performance of the resource does not meet the performance monitoring threshold (No), the performance determining portion 0341 is executed to obtain the performance requested by the operation process that uses the resource (step S1703). In the step S1703, the performance determining portion 0341 is executed to obtain the performance requested by the operation process that uses the resource, the operation process being searched in the step S1501, from the operation process requesting performance table 1101 through the use of the information reference portion 0342.

Further, the performance determining portion 0341 is executed to obtain the operation process whose requested performance is obtained in the step S1703 and the performance value of the same performance index type as the requested performance obtained in the step S1703 from the operation process performance table 0901 through the use of the information referencing portion 0342 (step S1704).

Then, the performance determining portion 0341 is executed to compare the requested performance obtained in the step S1703 with the performance value obtained in the step S1704 and determine if the performance of the operation process meets the requested performance (step S1705). If in the step S1705 the performance value meets the requested performance in every operation process (Yes), the performance determining portion 0341 is executed to compare the requested performance obtained in the step S1703 with the performance value obtained in the step S1704 and determine if the performance meets the requested performance with a margin in every operation process (step S1706). The expression of “with a margin” concretely means that the performance meets the requested performance with 30% surplus of the requested performance or the performance value meets the requested performance with a surplus of 2 milliseconds if the performance index is the response time.

If in the step S1706 the performance meets the requested performance with a margin in every operation process (Yes), the performance determining portion 0341 performs the process (step S1707) of relaxing the performance monitoring threshold through the use of the threshold setting portion 0344 for the purpose of relaxing the performance monitoring threshold. The detailed procedure of the process (step S1707) of relaxing the performance monitoring threshold will be described alter with reference to FIG. 19.

If in the step S1705 there exists even a single operation process in which the performance value does not meet the requested performance (No), the operation process is recorded (step S1708). In the step S1708, the performance determining portion 0341 is executed to relate the resource of which does not meet the performance monitoring threshold with the operation process of the requested performance unattainableness when they are stored in the relation table 1301 through the use of the threshold setting portion 0344.

Later than the step S1708, the performance determining portion 0341 is executed to invoke the client noticing portion 0345 so as to issue a problem-occurring alert to the management client 0106 (step S1709). In the step S1709, the client noticing portion 0345 is executed to notice to the management client 0106 the resource the performance of which does not attain the performance monitoring threshold and the operation process the performance of which does not attain the requested performance or meets the requested performance with no margin.

FIG. 18 is a flowchart showing the process of determining the pre-alert (step S1702). In this step, it is determined if a problem on the performance may take place and if possible, the client noticing portion 0345 is invoked so as to notice the possibility to the management client 0106. It is determined if the performance value of the resource meets the performance monitoring threshold with a margin based on the performance monitoring threshold and the performance value of the resource obtained in the steps S1503 and S1504 (step S1801). Herein, the expression of “the performance value meets the performance monitoring threshold with a margin” means that the performance value meets the performance monitoring threshold value with 30% surplus of the performance monitoring threshold or with a surplus of 2 milliseconds of the response performance if the performance index of the performance value and the performance monitoring threshold is the response performance.

If it is determined that the performance value meets the threshold (Yes) in the step S1801, the pre-alert determining process (step S1702) is finished. If it is determined that the performance value does not meet the threshold (No) in the step S1801, the process is executed to obtain the previously detected operation processes in which the requested performance is not achieved through the use of the performance threshold value the actual value is not determined to meet and the concerned operation process composition section (step S1802). In the step S1802, the process is executed to retrieve from the relation table 1301a record with a resource ID, an operation process composition section and a performance index type, same as the performance value of the resource compared in the step S1801 and obtain from the record an operation process of a requested performance unattainableness 1306 and an index of unattainableness 1307. The operation process of the unattainable requested performance and the index of unattainableness are noticed to the management client 0106 with a problem-noticing alert (step S1803). In the step S1803, they are noticed to the management client 0106 through the client noticing portion 0345.

FIG. 19 is a flowchart showing a process of enhancing an accuracy of the performance monitoring threshold (step S1707). In this process, if the performance of the operation process does not fall short of the requested performance by relaxing the condition of the performance monitoring threshold, the process is executed to reduce the times of determining that a performance problem took place based on the performance value of the resource and the performance monitoring threshold (that is, the times of redundant detections), thereby being able to enhance the accuracy of the performance monitoring threshold.

At first, the process is executed to search the number of the previous operation processes in which the requested performance is not attained, that is, the previous operation processes using the resource which do not meet the requested performance and the number of the redundant detections by monitoring the performance of the resource based on the current performance monitoring threshold (step S1901). In this step, the performance determining portion 0341 is executed to obtain the performance values of the resources with the same ID over a certain length of time from the resource performance table 1001 by using the information referencing portion 0342.

Further, the performance determining portion 0341 is executed to obtain, from the operation process performance table 0901, the operation processes the requested performance of which is obtained in the step S1703 and the performance values of the same performance index type as the requested performance obtained in the step S1703 over a certain length of time by using the information referencing portion 0342. Herein the expression of “a certain length of time” means a period when the previous performance information is being considered in the process of relaxing the threshold. For example, if the “certain length of time” is one week, it means that the performances of the resources and the operation processes of the last one week are considered when the threshold is determined. Then, the obtained performance of the operation process is compared with the requested performance. If the performance of the operation process meets the requested performance, it is determined that no problem took place. If the performance of the operation process does not meet the requested performance, it is determined that a problem took place.

At first, the performance of the resource is compared with the performance threshold. If the performance meets the performance threshold, it is determined that no problem took place. If not, it is determined that a problem took place. If it is determined that a problem took place in one or more operation processes using the resource and a problem took place in the resource, it means that the unattainable requested performance of the operation process is detected. Further, if it is determined that no problem took place in all operation processes using the resource but a problem took place in the resource, it means the redundant detection. The detection of the unattainable requested performances and the redundant detection are continued for a certain length of time. The former and the latter detections are added up respectively. The former total is defined as the number of the detections of the unattainable requested performance and the latter total is defined as the number of the redundant detections.

The process is executed to search the range of the performance monitoring threshold at which the number of the requested performance unattainablenesses of the previous operation processes, obtained in the Step S1901 to be detected as compared with the current threshold is kept stable and the number of the redundant detections becomes the smallest (step S1902). In the step S1902, the below-described processes (A) to (C) are repeated as changing the performance monitoring threshold in the process (A). The repetitive process is executed to search the range of the performance monitoring threshold at which the number of the detected requested performance unattainablenesses is made equal to the number searched in the step S1901 and the number of the redundant detections becomes the smallest.

(A) Relaxing the condition of the current performance monitoring threshold, the process is executed to search the number of the requested performance unattainablenesses and the redundant detections like the process of the step S1901.

(B) It is checked if the number of the requested performance unattainablenesses searched in the process A is the same as the number of the detected requested performance unattainablenesses searched in the step S1901.

(C) If it is checked that the former is the same as the latter in the process (B), it is checked if the number of the redundant detections searched in the process (A) is smaller than the number of the redundant detections searched in the step S1901. If both are the same or the former is smaller than the latter, the performance monitoring threshold set in the process (A) is specified as the range of the performance monitoring threshold.

The value of the most relaxed condition in the range of the performance monitoring threshold searched in the step S1902 is specified as a new performance monitoring threshold (step S1903). In the step S1903, the value of the most relaxed condition in the range of the performance monitoring threshold searched in the step S1902 is overwritten on the performance monitoring threshold 1205 of the record with the same resource ID, the same operation process composition section and the same performance index type of the resource performance monitoring threshold table 1201. If there is no range of the performance monitoring threshold, the performance monitoring threshold is not changed.

FIG. 20 is a flowchart showing the process of determining the requested performance unattainableness of the operation process is not detected by monitoring the performance of the resource and tightening the condition of the performance monitoring threshold of the resource so that the unattainableness can be detected (step S1506).

The performance determining portion 0341 is executed to obtain the requested performance from the operation process requested performance table 1101 through the use of the information referencing portion 0342 (step S2001). The performance determining portion 0341 is executed to obtain the performance value of the most previous operation process from the operation process performance table 0901 through the use of the information referencing portion 0342 (step S2002).

The performance determining portion 0341 is executed to determine if the performance of the operation process meets the requested performance based on the requested performance and the performance value of the operation process obtained in the steps S2001 and S2002 (step S2003). In the step S2003, if the performance of the operation process meets the requested performance (Yes), the process of determining whether or not the performance problem of the operation process is detected (step S1506) is finished.

If in the step S2003 it is determined that the performance of the operation process does not meet the requested performance (No), the performance determining portion 0341 is executed to search if the operation process is recorded in the relation table 1301 (step S2004). In the step S2004, the information referencing portion 0342 is executed to search if there exists a record in which the application name, the operation process name, the performance index type and the data obtaining time obtained in the step S2002 are matched to the information filled in the columns of the application name 1305, the requested performance unattainable operation process 1306, the index of unattainableness 1307 and the data obtaining time 1308.

If in the step S2004 there is no record in which the former is matched to the latter (Yes), the threshold is tightened (step S2005). The detailed procedure of the step S2005 will be described below with reference to FIG. 21. If in the step S2004 there exists a record in which the former is matched to the latter (No), the process of determining if the performance problem of the operation process is detected (step S1506) is finished.

FIG. 21 is a flowchart showing a process (step S2005) of setting the performance monitoring threshold of the resource so as to allow the undetected requested performance unattainableness of the operation process to be detected. This process is executed by the threshold setting portion 0344.

At first, the process is executed to search the resource and its performance type in which the undetected requested performance unattainableness can be detected (step S2101). For example, the resource in which the performance problem of the operation process can be detected and its performance index type, specified in the steps S2101, has the highest relation between the performance of the performance index type in which the requested performance is not attained and the performance of the resource used by the operation process.

Then, in the resource and its performance index type selected in the step S2101, the process is executed to search the range of the performance monitoring threshold in which the undetected performance problem of the operation process can be detected and the number of the redundant detections becomes the smallest (step S2102). In the step S2102, the following processes (D) and (E) are repeated as changing the performance monitoring threshold in the process (D) in order to search the range of the performance monitoring threshold in which the number of the redundant detections becomes the smallest.

(D) The process is executed to detect the undetected requested performance unattainableness of the operation process with respect to the performance monitoring threshold. If not detected, the condition of the performance monitoring threshold is changed to be more severe, and then the process (D) is executed again.

(E) The process is executed to derive the number of the redundant detections with respect to the performance monitoring threshold at which the detected unattainableness of the operation process can be detected in the process (D). The performance monitoring threshold at which the number of the redundant detections is the smallest is specified as the range of the performance monitoring threshold.

The process is executed to set to a candidate threshold the value that is furthest from the condition being attained in the range of the performance monitoring threshold searched in the step S2102 (step S2103). The threshold setting portion 0344 is executed to search if the resource and its performance index type of the selected candidate threshold have been already set in the operation process composition section in which the requested performance unattainableness of the operation process could not be detected (step S2104). In the step S2104, the threshold setting portion 0344 is executed to obtain the operation process composition section of the resource of the candidate threshold selected in the step S2103 through the use of the information referencing portion 0342. The threshold setting portion 0344 is executed to search if the resource performance monitoring threshold table 1201 stores a record in which the obtained operation process composition section, the resource of the candidate threshold selected in the step S2103, and the performance index type of the candidate threshold are the same through the use of the information referencing portion 0342.

If in the step S2104 the record has been already stored in the table 1201 (Yes), the threshold setting portion 0344 is executed to update the performance monitoring threshold stored in the table 1201 with the candidate threshold (step S2105). If in the step S2104 the record is not stored in the table 1201 (No), the threshold setting portion 0344 is executed to store (add) the candidate threshold as the performance monitoring threshold in the table 1201 (step S2106).

After the processes in the steps S2105 and S2106, the threshold setting portion 0344 is executed to store in the relation table 1301 the performance monitoring threshold set in the step S2105 or S2106 and the operation process that does not attain the requested performance in the state of relating them with each other. That is, the operation process in which a problem took place is recorded (step S2107).

As described above, the storage system S according to this embodiment is capable of properly setting the performance monitoring threshold to the storage resource and monitoring the performance of the storage resource in the SAN environment according to the operation process being executed. That is, by properly tightening or relaxing the performance monitoring threshold about the logical volume 0121, the monitored performance of the logical volume 0121 is matched between the operation server 0102 and the storage device 0104.

This is the end of the description of the embodiments of the invention. However, the invention is not limited to the foregoing embodiments.

For example, the number of the operation processes sharing the logical volume 0121 may not be two but three or more. Additionally, the concrete arrangements of the hardware and the programs may be properly modified without departing from the spirit of the invention.

1. A storage management system configured to have a host computer for executing an operation process, a storage device for supplying a storage area to be used when the operation process is executed, a storage network to be used for communicating data between the host computer and the storage device, and a management server being connected with the host computer and the storage device, comprising:
the management server having;
a performance information collecting unit which collects a current performance value of the storage device related with a performance value based on a throughput or a response time about the operation process and a storage resource whose performance information is to be collected, located in the storage network,
a composition section determining unit which determines a composition section corresponding with a composition ratio of composition processes based on a processing amount of those operation processes sharing the storage resource,
a threshold information storage unit which stores a threshold of the performance value for the composition ratio as a performance monitoring threshold with respect to one or more storage resources, and
a performance determining unit which determines a performance of the storage resource based on the performance monitoring threshold read from the threshold information storage unit in correspondence with the current performance value collected by the performance information collecting unit and a current composition section determined by the composition section determining unit.

2. The storage management system as claimed in claim 1, wherein the performance determining unit determines that no performance problem takes place when the performance value of each of the operation processes sharing the storage resource meets a requested performance value predetermined with respect to the operation process with a predetermined margin range even if the current performance value does not meet the performance monitoring threshold corresponding with the current composition section determined by the composition section determining unit.

3. The storage management system as claimed in claim 2, wherein the performance determining unit determines the predetermined margin range based on an absolute magnitude of the requested performance value or a ratio of the requested performance value.

4. The storage management system as claimed in claim 1, wherein the composition section determining unit determines the composition section based on the absolute magnitude of the processing amount of the operation processes.

5. The storage management system as claimed in claim 1, wherein the composition section determining unit determines the composition section based on the ratio of the processing amount of the operation processes.

6. The storage management system as claimed in claim 1, wherein the performance determining unit notices to a management client connected with the management server a possibility that a performance problem may take place if the current performance value does not meet the performance monitoring threshold corresponding with the current composition section determined by the composition section determining unit.

7. The storage management system as claimed in claim 6, wherein the threshold information storage unit stores the fact that the requested performance value predetermined with respect to the operation process was not met in the past and the performance monitoring threshold corresponding with the composition section in which the fact can be detected in combination with each other, and when the occurring possibility of the performance problem is noticed to the management client, the performance determining unit retrieves the threshold information storage unit and notifies the operation processes with the same composition section and the same performance monitoring threshold and the performance problem took place in the past together with the possibility.

8. The storage management system as claimed in claim 6, wherein the performance determining unit determines the predetermined margin range based on an absolute magnitude of the performance monitoring threshold or a ratio of the performance monitoring threshold.

9. The storage management system as claimed in claim 1, wherein the management server further has a threshold setting unit which sets a performance monitoring threshold corresponding with the composition section to the storage resource, and the threshold setting units sets the performance monitoring threshold to the storage device based on the performance values collected by the performance information collecting unit and the predetermined requested performance value of the operation process using the storage resource.

10. The storage management system as claimed in claim 9, wherein if the performance value of the operation process using the storage resource does not meet the requested performance value, the threshold setting unit resets the performance monitoring threshold of the threshold information storage unit more tightly at a time when the performance value does not attain the requested performance value, when the performance determining does not detect shortage of the performance of the storage resource, and if the performance value of the operation process using the storage resource meets the requested performance value, the performance determining unit resets the performance monitoring threshold of the threshold information storage unit more relaxedly at a time when the performance value attains the requested performance value, when the performance determining unit detects shortage of the performance of the storage resource.

11. The storage management system as claimed in claim 10, wherein when resetting the performance monitoring threshold of the threshold information storage more tightly, the threshold setting unit sets as the performance monitoring threshold the performance value of the storage resource at a time when the performance value does not attain the requested performance value, and when resetting the performance monitoring threshold of the threshold information storage unit more relaxedly, the threshold setting unit sets as the performance monitoring threshold the performance value of the storage resource at a time when the performance value attains the requested performance value.

12. The storage management system as claimed in claim 9, wherein the management server further has a performance information storage unit which stores the performance values collected by the performance information collecting unit, and the threshold setting unit resets the performance monitoring threshold of the threshold information storage unit so as to allow the performance determining unit to detect all of the previous facts that the operation process does not meet the requested performance in light of the performance of the storage resource, based on the performance information stored in the performance information storage unit and the requested performance value.

13. A method of monitoring a performance in a storage management system configured to include a host computer for executing an operation process, a storage device for supplying a storage area to be used when the operation process is being executed, a storage network to be used for communicating data between the host computer and the storage device, and a management server being connected with the host computer and the storage device and having a threshold information storage unit for storing a threshold of a performance value based on a throughput or a response time of the operation process as a performance monitoring threshold in correspondence with a composition section corresponding with a composition ratio of the operation process sharing the storage device related with the performance value and one or more storage resources whose performance information is to be collected in the storage network, comprising the steps of:
in the management server,
collecting the current performance value about the storage resources through a performance information collecting unit;
determining a current composition section of the operation process based on a processing amount of the operation process sharing the storage resources through a composition section determining unit; and
determining the performance of the storage resources based on a current performance value collected by the performance information collecting unit and the performance monitoring threshold read from the threshold information storage unit in correspondence with the current composition section determined by the composition section determining unit.

14. The performance monitoring method as claimed in claim 13, wherein even if the current performance value does not meet the performance monitoring value corresponding with the current composition section determined by the composition section determining unit, when the performance value of each of the operation processes sharing the storage resource meets the requested performance value preset to the operation process with a predetermined margin range, the performance determining unit determines that no performance problem takes place.

15. The performance monitoring method as claimed in claim 14, wherein the performance determining unit determines the predetermined margin range based on an absolute magnitude of the requested performance value and a ratio of the requested performance value.

16. The performance monitoring method as claimed in claim 13, wherein the composition section determining unit determines the composition section based on an absolute magnitude of the processing amount of the operation processes.

17. A management server included in a storage management system configured to have a host computer for executing an operation process, a storage device for supplying a storage area to be used when the operation process is being executed, a storage network to be used for communicating data between the host computer and the storage device, and the management server being connected with the host computer and the storage device, comprising:
a performance information collecting unit which collects a current performance value of the storage device related with a performance value based on a throughput or a response time of the operation process and storage resources whose performance information is to be collected in the storage network;
a composition section determining unit which determines a composition section corresponding with a composition ratio of the operation processes based on a processing amount of the operation processes sharing the storage resources;
a threshold information storage unit which stores a threshold of the performance value corresponding with the composition section as a performance monitoring threshold with respect to one or more of the storage resources; and
a performance determining unit which determines a performance of the storage resource based on the current performance value collected by the performance information collecting unit and the performance monitoring threshold read from the threshold information storage unit corresponding with a current composition section determined by the composition section determining unit.

18. The management server as claimed in claim 17, wherein if the current performance value does not meet the performance monitoring threshold corresponding with the current composition section determined by the composition section determining unit, when the performance value of each of the operation processes sharing the storage resource meets the requested performance value preset to the operation process with a predetermined margin range, the performance determining unit determines that no performance problem takes place.

19. The management server as claimed in claim 18, wherein the performance determining unit determines the predetermined margin range based on an absolute magnitude of the requested performance value and a ratio of the requested performance value.

20. The management server as claimed in claim 17, wherein the composition section determining unit determines the composition section based on an absolute magnitude of the processing amount of the operation processes.
